(19) United States
(12) Patent Application Publication
(10) Pub. No.: US 2025/0037134 A1
(43) Pub. Date: Jan. 30, 2025

(54) FLEXIBLE ENGINE FOR PROCESSING STORED VALUE PAYMENT VEHICLES

(71) Applicant: Worldpay, LLC, Symmes Township, OH (US)

(72) Inventor: Jackson Andrew UNRAU, Littleton, CO (US)

(73) Assignee: Worldpay, LLC, (omitted)

(21) Appl. No.: 16/843,495

(22) Filed: Apr. 8, 2020

Related U.S. Application Data
(63) Continuation of application No. 14/547,349, filed on Nov. 19, 2014, now abandoned.

(51) Int. Cl. G06Q 20/40; G06Q 20/34

(52) U.S. Cl. CPC G06Q 20/405; G06Q 20/342; G06Q 20/349

(57) ABSTRACT

Systems and methods are disclosed for using a stored value payment vehicle processing engine to receive a stored value processing rule defining one or more of a stored value processing filter and a transaction velocity; and to associate a stored value payment vehicle with the stored value processing rule. Once associated, an authorization request is received for payment and approval of authorization request is determined.

### TECHNICAL FIELD

The systems and methods described below relate generally to the field of stored value payment vehicle processing techniques. More particularly, the systems and methods relate to the field of establishing rules for processing stored value payment vehicles.

### BACKGROUND

Millions of transactions occur daily through the use of payment cards, such as credit cards, debit cards, prepaid cards, and so forth. Such volume requires greater flexibility for processing engines needed to provide real-time authorization for payment transactions. Many conventional processing engines do not easily integrate into existing commercial payment platforms using stored value payment vehicles, and do not offer end users the opportunity to configure the system with respect to authorization of payment transactions. Thus, it may be desirable to establish a payment processing platform and methods associated therewith to provide greater flexibility when processing payments associated with stored value payment vehicles.

### SUMMARY

In an embodiment, the present disclosure is directed, in part, to a computer-implemented method. The computer-implement method comprises providing, by a stored value payment vehicle processing engine, a stored value dashboard. The method also comprises receiving, at the stored value payment vehicle processing engine, a stored value processing rule. The stored value processing rule defines one or more of a stored value processing filter, a transaction velocity, and at least one load parameter, The stored value processing rule is received through an input to the stored value dashboard. The method also comprises storing, in a processing database communicably coupled to the stored value payment vehicle processing engine, the stored value processing rule. The method also comprises associating, by the stored value payment vehicle processing engine, the stored value processing rule with a stored value payment vehicle. The method also comprises subsequent to associating the stored value processing rule with a stored value payment vehicle, receiving one of an authorization request from a point of sale device associated with a merchant for a transaction initiated by the stored value payment vehicle and a request to load funds onto the stored value payment vehicle. The method also comprises in response to receiving the authorization request, determining, by the stored value payment vehicle processing engine, whether to approve the authorization request based on the stored value processing rule in the processing database. The method also comprises in response to receiving the request to load funds onto the stored value payment vehicle, determining, by the stored value payment vehicle processing engine, whether to approve the request to load funds based on the stored value processing rule stored in the processing database.

In an embodiment, the present disclosure is directed, in part, to a computer-implemented method. The computer-implement method comprises receiving, at a stored value payment vehicle processing engine, a stored value processing rule defining at least a transaction velocity and an acceptable load velocity. The stored value processing rule defines one or more of a stored value processing filter and a transaction velocity. The method also comprises associating, by the stored value payment vehicle processing engine, the stored value processing rule with a stored value payment vehicle. The method also comprises subsequent to associating the stored value processing rule with a stored value payment vehicle, receiving, by payment processing computing system, transaction data from a merchant for a purchase transaction. The transaction data comprises an authorization request and identified an account of a payment card. The payment processing computing system comprises the stored value payment vehicle processing engine. The method also comprises determining, by the payment processing computing system, whether the payment card is the stored value payment vehicle. The method also comprises when the payment card is the stored value payment vehicle, determining, by the stored value payment vehicle processing engine, whether to approve the authorization request based on the stored value processing rule.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts an example payment network system to authorize payment transactions utilizing stored value payment vehicles.

FIG. 2 schematically depicts an example payment processing platform utilized in the system shown in FIG. 1.

FIG. 3 depicts an example process flow seeking authorization of a payment transaction in accordance with one non-limiting embodiment.

FIG. 4 depicts an example computing device.

### DETAILED DESCRIPTION

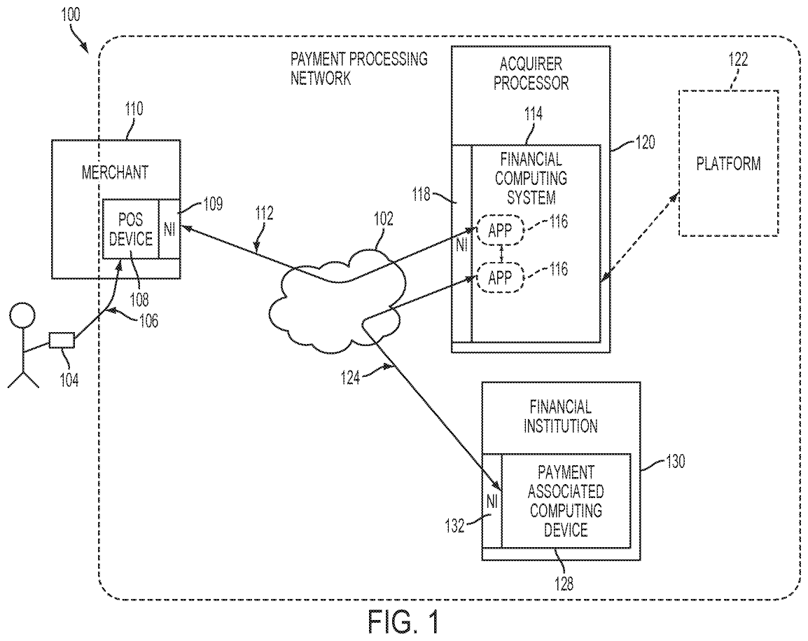

Various non-limiting embodiments of the present disclosure will now be described to provide an overall understanding of the principles of the structure, function, and use of systems, apparatuses, devices, and methods disclosed herein for the processing of stored value payment vehicle payment transactions. One or more examples of these non-limiting embodiments are illustrated in the selected examples disclosed and described in detail with reference made to FIGS. 1-4 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to a “payment vehicle,” which generally refers to any type of financial alternative to currency. As is to be clear to those skilled in the art, no aspect of the present disclosure is specifically limited to a specific type of payment vehicle. Therefore, it is intended that the following description encompasses the use of the present disclosure with many other forms of financial alternatives to currency, including credit card, debit cards, smart cards, single-use cards, pre-paid cards, electronic currency (such as might be provided through a cellular telephone or personal digital assistant), and the like. Payment vehicles can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored value cards, or any other like financial transaction instrument. A payment vehicle can also have electronic functionality provided by a network of electronic circuitry that is printed or otherwise incorporated onto or within the payment vehicle (and typically referred to as a “smart card”), or be a fob having a transponder and an RFID reader.

FIG. 1 depicts a block diagram of an example payment processing network 100. An example payment processing network 100 can include a payment terminal, for example a point-of-sale (POS) device 108 of a merchant 110, a financial computing system 114 of an acquirer processor 120, a payment associated computing device 128 of a financial institution 130, and a network 102, among other computing devices. The point-of-sale device 108 and the financial computer system 114 can be payment associated computing devices, or include one or more payment associated computing devices as appropriate.

In the example payment processing network 100, a payment vehicle user presents a payment vehicle 104 to a merchant 110 for payment 106 of goods or services at a point-of-sale device 108 associated with the merchant 110. The present disclosure is not limited to any particular type of POS device or merchant. As used herein, the term POS device is used broadly to include POS devices at brick and mortar locations and “virtual” POS devices that can be associated with an online retailor or “in-app” purchases. The term merchant is used broadly to include brick-and-mortar merchants, online merchants, or any other type of entity or device capable of receiving payment from a payment vehicle transaction. In some cases, the POS device includes a terminal, or other network computing system which may be used to facilitate a payment transaction at a merchant location. Thus, the POS device 108 can be any type of device, physical or virtual, used by the merchant 110 to communicate payment-related information to an acquirer processor 120. As is to be appreciated, the POS device 108 can directly send the transaction data to the acquirer processor 120 or indirectly send transaction data through gateways or other payment processing platforms. The acquirer processor 120 generally accepts or acquires payment card payment from issuing financial institutions 130 within an association. Examples of credit card associations are VISA®, MASTERCARD®, DISCOVER®, AMERICAN EXPRESS®, and DINERS CLUB®.

In one example, the payment vehicle 104 is a stored value payment vehicle. Such stored value payment vehicles can exist within an open system, as generally described in FIG. 1, or a closed system. In a closed system, the stored value payment vehicle can only be used at one or more designated merchants. These closed systems do not utilize payment networks (i.e., VISA® or MASTERCARD®). In an open system, a stored value payment vehicle may be used for purchases from any merchant connected to a payment network (i.e., VISA® or MASTERCARD®), either through system-based service or through other means.

In the example payment processing network 100, a payment vehicle user can also attempt to load funds onto the stored value payment vehicle. The user can attempt to load onto the stored value payment vehicle at a POS device 108 (such as an automated teller machine, for example), interacting with various online portals, or through other techniques as are generally known in the art.

As illustrated in FIG. 1, the merchant 110 (only one shown for clarity) can be any type of merchant, such as a brick-and-mortar merchant, an online merchant, a mobile merchant, a kiosk, or any other type of merchant or device configured to receive payment cards from account holders as a form of payment. Various entities which may also be part of the payment ecosystem, such as various types of gateways or other service providers, are not included in FIG. 1 for clarity. In the illustrated embodiment, the payment vehicle 104 is issued by a financial institution 130. The merchant 110 utilizes the acquirer processor 120, sometimes referred to as a merchant acquirer or merchant acquirer processor, to processes payment vehicle transactions, shown as payment transactions 112. An example payment transaction 112 is an authorization request from the point-of-sale device 108 for funds from the financial institution 130 that issued the payment vehicle 104.

The point-of-sale device 108 can include a network interface 109 that allows the point-of-sale device 108 to transmit the payment transaction 112 across the network 102. The payment transaction 112 is received at the network interface 118 of the financial computing system 114 of the acquirer processor 120. The acquirer processor 120 processes the payment transaction 112 for the merchant 110. The acquirer processor 120 can seek authorization 124 for payment transaction 112 originating from the merchant 110 from the financial institution 130. A bank authorization request (BAU request) for a requested amount of funds can be sent to the payment associated computing device 128 of the financial institution 130, for example. The BAU request can be transmitted from the network interface 118 of the financial computing system 114 to the network interface 132 of the payment associated computing device 128 of the financial institution 130. As is to be appreciated, the authorization 124 can be routed through various entities within a payment network 100, and use different network interfaces associated with different computing devices as would be understood in the art. In response to the BAU request, the payment associated computing device 128 of the financial institution 130 can send a bank authorization response (BAU response), for example an approval response, to the financial computing system 114 of the acquirer processor 120 for the amount of the payment transaction 112, and the financial computing system 114 can inform the point-of-sale device 108 of the merchant 110 that the payment transaction 112 is authorized. The acquirer processor 120 can then electronically credit and settle the funds into the respective accounts as is known or would be understood in the art. See, for example, U.S. patent application Ser. No. 13/653,443 filed on Oct. 17, 2012 titled Systems, Methods and Apparatus for Variable Settlement Accounts.

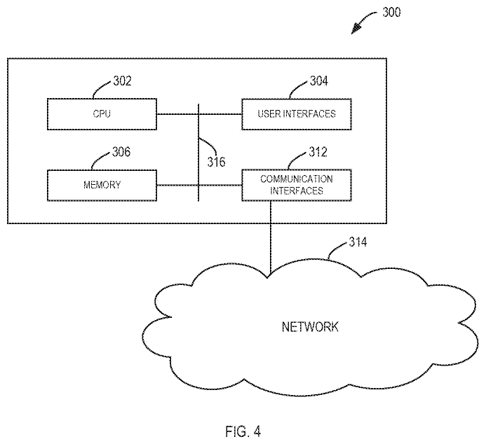

The financial computing system 114 of the acquirer processor 120 can execute multiple payment processing applications 116. The financial computing system 114 can be any suitable computing device 300 (FIG. 4), including multiple computing devices, virtual computing devices, networked computing devices, and so forth as would be known or understood in the art. The applications 116 can execute on one or multiple computing devices 300. Example payment processing applications 116 can include a process for receiving payment transactions 112 from merchants 110 and for sending payment authorizations to merchants 110, a process for communicating with payment associated computing devices 128 at financial institutions 130, for example to send BAU requests and received BAU responses, a settlement engine for settling received funds into settlement accounts based on rules or other configurations, a process for settling funds with financial institutions 130, and so forth. For any particular payment process, various processes can execute concurrently while other processes execute serially.

Although the financial computing system 114 is illustrated as executing on a computing device 300 (see FIG. 4) associated with the acquirer processor 120, the financial computing system 114 can be an independent computing device, a distributed computing system, a computing device associated with a third party, a computing device associated with the financial institution 130, or any other suitable party.

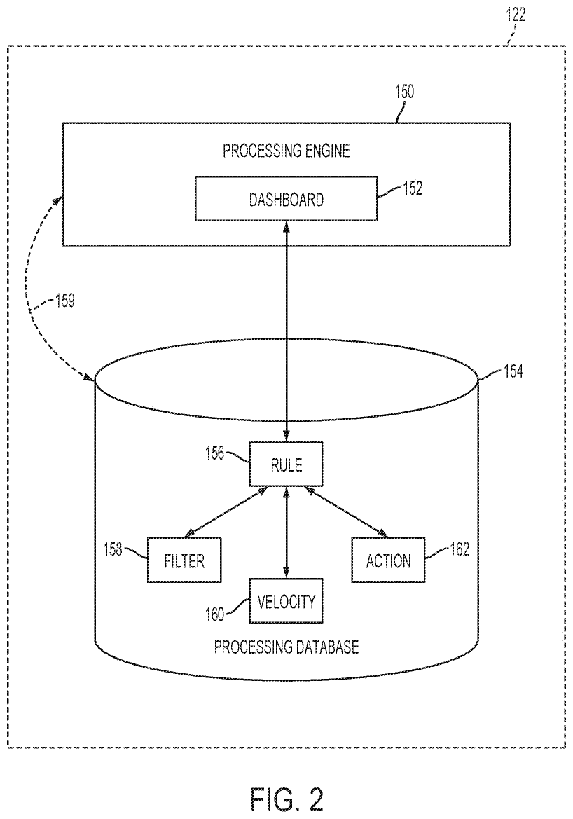

In one example, the applications 116 can be performed on a payment processing platform 122. As more clearly shown in FIG. 2, the payment processing platform 122 includes a stored value payment vehicle processing engine 150 communicably coupled 159 to a processing database 154. The processing database 154 can store one or more stored value processing rules 156. Such stored value processing rules 156 can define stored value processing filters 158, transaction velocities 160 and actions 162. It will be appreciated that in other embodiments, the processing database 154 can be housed remotely from the payment processing platform 122. In one embodiment, the stored value payment vehicle processing engine 150 can provide a stored value dashboard 152 having an input (e.g., graphical user interface) which permits receiving such stored value processing rules 156 at the stored value payment vehicle processing engine 150. In some embodiments, the stored value payment vehicle processing engine 150 can be a backend subsystem of the acquirer processor 120 which enables the creation, activation, modification, and/or execution of these stored value processing rules 156.

The stored value processing rules 156 may be inputted by and stored by the acquirer processor 120, but in certain examples, the rules 156 are received from the cards issuer, or other affiliated entity (i.e., a merchant) of the stored value payment vehicle. In another example, the card issuer has the ability control the stored value dashboard 152 in order to establish and set the stored value processing rules 156, including defining the stored value processing filters 158, transaction velocities 160 and actions 162, associated with one or more stored value payment vehicles. Again, the payment processing platform 122 can generally provide greater flexibility to modify the specific protocol associated with any stored value payment vehicle within the payment system, thereby providing an association between such rules 156 (and filters 158, transaction velocities 160 and actions 162) and stored value payment vehicles.

Stored value processing rules 156 can define a number of protocols. For example, stored value processing rules 156 can define one or more of an acceptable stored value processing filter 158, an acceptable transaction velocity 160 for the stored value payment vehicle, and an acceptable action 162. Such stored value processing filters 158 can include: acceptable geographic location for the merchant (e.g., whether or not to permit transactions originating from a foreign location) an acceptable merchant (e.g., Merchant is an Auto Rental, Bank Teller, Hotel, or not a competitor to the issuer, etc.), and a variety of other suitable stored value processing filters which may be beneficial to the card issuer, a merchant, or the acquirer processor 120. Such transaction velocities 160 can include: an acceptable spend limit for a spending period, acceptable number of transaction during a spending period (e.g., no more than 4 transactions per minute), the value of a transaction, and a variety of other suitable transaction velocities which may be beneficial to the card issuer, a merchant, or the acquirer processor 120. Such actions 162 can include: permissions to allow certain overrides at the stored value payment vehicle level, whether to permit fees associated with the stored value payment vehicle (e.g., real-time fees), and a variety of other suitable actions which may be beneficial to the card issuer, a merchant, or the acquirer processor 120. In certain examples, where multiple stored value processing rules 156 are available, a list of such rules 156 are provided and a selection of these rules 156 can be made and associated with one or more of the stored value payment vehicles.

In some embodiments, the stored value processing rules 156 can include load parameters for handling load requests. In response to the receiving the request to load funds onto the stored value payment vehicle 104, payment processing platform 122 can determine whether the request to load funds should be approved based on the stored value processing rules 156 stored in the processing database 154. The stored value processing rules 156 can include, for example, an acceptable load velocity, a load minimum, or a load maximum based on a maximum allowable balance of the payment vehicle. Acceptable load velocities for each of a plurality of load transaction types can be established at stored in the processing database 154. Accordingly, an acceptable load velocity for cash-based loads may differ to an acceptable load velocity for a direct deposit-based load and/or an account transfer-based load. In any event, in accordance with the present disclosure, various rules and processing parameters for load requests can be stored payment processing platform 122 and then be used to process load requests.

At the stored value dashboard 152, an authorized user can maintain card management data associated with a stored value payment vehicle. Such card management data can include the stored value processing rules 156 which can be associated with a specific stored value payment vehicle. For example, these rules 156 can include a set of conditions that are evaluated and processed by the stored value payment vehicle processing engine 150. In one example, a stored value processing rule 156 is applicable to a plurality of stored value payment vehicles. In one example, once a selection of stored value processing rules 156 is received, a plurality of available stored value processing filters 158, a plurality of available stored value transaction velocity 160, and a plurality of available actions 162 can be provided through and received at the stored value dashboard 152. In one example, the stored value dashboard 152 can be a web-based portal which provides the card management data and permits an authorized user to add to, modify or execute, rules 156, including the filters 158, transaction velocities 160 and actions 162, and other suitable business parameters which may be important to card issuers or acquirer processors 120.

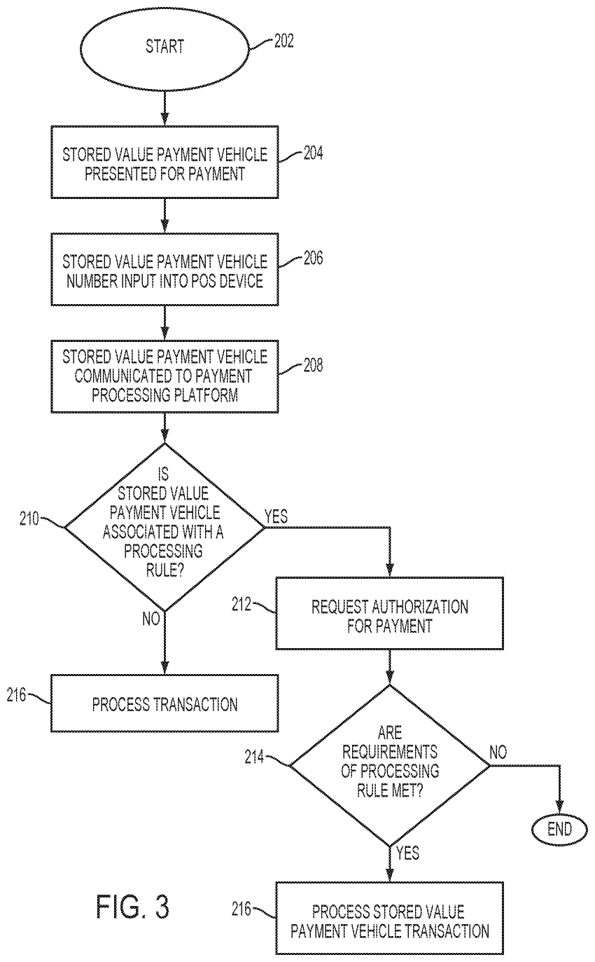

The processing payment platform 122 described herein provides a method for providing end users with greater flexibility in creating, modifying and executing certain processing rules 156 which are associated with a stored value payment vehicle. As illustrated in the non-limiting embodiment of FIG. 3, a method can START 202 when a consumer decides to use their respective stored value payment vehicle at a merchant, such that STORED VALUE PAYMENT VEHICLE PRESENTED FOR PAYMENT 204. Often this means that the consumer has the stored value payment vehicle read by a POS device located at the merchant, such that STORED VALUE PAYMENT VEHICLE NUMBER INPUT INTO POS DEVICE 206. Next, the stored value payment vehicle is identified and put into communication with a payment processing platform, such that STORED VALUE PAYMENT VEHICLE COMMUNICATED TO PAYMENT PROCESSING PLATFORM 208. Then, the payment processing platform evaluates whether the stored value payment vehicle is associated with any stored value processing rules, such that IS STORED VALUE PAYMENT VEHICLE ASSOCIATED WITH A PROCESSING RULE 210. If it is determined that the stored value payment vehicle is in fact not associated with a stored value processing rule then the payment transaction is processed, but if the stored value payment vehicles has the proper association, then a request for authorization of the payment is made, such that REQUEST AUTHORIZATION FOR PAYMENT 212. Next, a determination is made as to whether the processing rule is met, such that ARE REQUIREMENTS OF PROCESSING RULE MET 214. In some cases, during such determination characteristics of the payment transaction can be compared against processing filters and/or transaction velocities associated with the processing rule. If the requirements of the processing rule are not met, then the authorization of the payment is denied. If the requirements are met, the payment transaction is authorized and payment is processed, such that PROCESS STORED VALUE PAYMENT VEHICLE TRANACTION 216. The method described in FIG. 3 is only one example of how payment transactions involving stored value payment vehicles associated with more robust and flexible processing engines can operate.

In other examples, a selection of one of plurality of available stored value processing filters 158 and selection of one of the plurality of available stored value transaction velocity 160 can be received. Thus, in this example, the determination as to whether to approve the authorization request for payment is based on the selected stored value processing filter 160 and the selected stored value transaction velocity 162.

In other examples, when the stored value processing rule 156 is received certain processing parameters for implementation of the stored value process rule can be received. These processing parameters can include any of a start date and end date.

While general similar to the method described in FIG. 3, other examples, may receive (after associating the stored value processing rule with a stored value payment vehicle), by a payment processing computing system, transaction data from a merchant for a purchase transaction. The payment processing computing system may be a POS device 108 or other processing device to provide the relevant transaction data. The transaction data may include an authorization request and identify an account of a payment card. The payment processing computing system may include the stored value payment vehicle processing engine. Further, such a method may also include determining whether the payment card is a stored value payment vehicle prior to authorization, and if it is determined to be a stored value payment vehicle, to then determine whether to approve the authorization request based on the stored value processing rule.

The methods described herein can be performed on or between one or more computing devices. Referring now to FIG. 4, an example computing device 300 is presented. A computing device 300 can be a server, a computing device that is integrated with other systems or subsystems, a mobile computing device, a cloud-based computing capability, and so forth. The computing device 300 can be any suitable computing device as would be understood in the art, including without limitation, a custom chip, an embedded processing device, a tablet computing device, a point of sale device 108, the financial computing system 114, the platform 122, the payment associated computing device 128, a back office system, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

The computing device 300 includes a processor 302 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 300 also includes one or more memories 306, for example read only memory (ROM), random access memory (RAM), cache memory associated with the processor 302, or other memories such as dynamic RAM (DRAM), static ram (SRAM), programmable ROM (PROM), electrically erasable PROM (EEPROM), flash memory, a removable memory card or disk, a solid state drive, and so forth. The computing device 300 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 302, or memories 306 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 312 can be configured to transmit to, or receive data from, other computing devices 300 across a network 314. The network and communication interfaces 312 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 312 can include wired data transmission links such as Ethernet and TCP/IP. The communication interfaces 312 can include wireless protocols for interfacing with private or public networks 314. For example, the network and communication interfaces 312 and protocols can include interfaces for communicating with private wireless networks such as a WiFi network, one of the IEEE 802.11x family of networks, or another suitable wireless network. The network and communication interfaces 312 can include interfaces and protocols for communicating with public wireless networks 312, using for example wireless protocols used by cellular network providers, including Code Division Multiple Access (CDMA) and Global System for Mobile Communications (GSM). A computing device 300 can use network and communication interfaces 312 to communicate with hardware modules such as a database or data store, or one or more servers or other networked computing resources. Data can be encrypted or protected from unauthorized access.

In various configurations, the computing device 300 can include a system bus 316 for interconnecting the various components of the computing device 300, or the computing device 300 can be integrated into one or more chips such as programmable logic device or application specific integrated circuit (ASIC). The system bus 316 can include a memory controller, a local bus, or a peripheral bus for supporting input and output devices 304, and communication interfaces 312. Example input and output devices 304 include keyboards, keypads, gesture or graphical input devices, motion input devices, touchscreen interfaces, one or more displays, audio units, voice recognition units, vibratory devices, computer mice, and any other suitable user interface.

The processor 302 and memory 306 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein. Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

1-22. (canceled)

23. A computer-implemented method, comprising:
receiving, at a stored value transaction vehicle processing engine comprising one or more servers operating on a network and implemented in an acquirer processor, a stored value processing rule defining at least a transaction velocity and an acceptable load velocity that restricts amount loaded onto a stored value transaction vehicle, wherein the acceptable load velocity include a first load velocity associated with cash-based loads and a second load velocity associated with deposit-based and/or account-transfer-based loads;
associating, by the stored value transaction vehicle processing engine, the stored value processing rule with the stored value transaction vehicle;
receiving, by a transaction processing computing system, a request to load funds onto the stored value transaction vehicle;
determining, by the stored value transaction vehicle processing engine, to load the funds onto the stored value transaction vehicle based, at least in part, on meeting requirements of the stored value processing rule;
receiving, by the transaction processing computing system, transaction data from an entity for a purchase transaction, wherein the transaction data comprises an authorization request and identifies an account of a transaction vehicle, wherein the transaction processing computing system comprises the stored value transaction vehicle processing engine;
comparing, by the stored value transaction vehicle processing engine, the transaction data against the stored value processing rule;
determining, by the stored value transaction vehicle processing engine, the transaction vehicle is the stored value transaction vehicle based on the comparison;
determining, by the stored value transaction vehicle processing engine, to approve the authorization request based, at least in part, on meeting requirements of the stored value processing rule; and
processing, by the transaction processing computing system, a transaction associated with the transaction data using the stored value transaction vehicle, based at least in part on the determining to approve the authorization request.

24. The computer-implemented method of claim 23, wherein the stored value processing rule is applicable to a plurality of stored value transaction vehicles.

25. The computer-implemented method of claim 24, wherein the stored value processing rule is received from a transaction vehicle issuer system associated with the stored value transaction vehicle.

26. The computer-implemented method of claim 23, wherein the transaction velocity defines an acceptable spend limit within a spending period.

27. The computer-implemented method of claim 23, wherein receiving the stored value processing rule comprises receiving processing parameters for implementation of the stored value processing rule, wherein the processing parameters comprise any of a start date and an end date.

28. (canceled)

29. The computer-implemented method of claim 23, wherein the acceptable load velocity of the stored value processing rule comprises acceptable load velocities for each of a plurality of load transaction types.

30. (canceled)

31. A system comprising:
one or more processors;
one or more computer readable media storing instructions which, when executed by the one or more processors, cause the one or more processors to perform operations comprising:
receiving, at a stored value transaction vehicle processing engine comprising one or more servers operating on a network and implemented in an acquirer processor, a stored value processing rule defining at least a transaction velocity and an acceptable load velocity that restricts amount loaded onto a stored value transaction vehicle, wherein the acceptable load velocity include a first load velocity associated with cash-based loads and a second load velocity associated with deposit-based and/or account-transfer-based loads;
associating, by the stored value transaction vehicle processing engine, the stored value processing rule with the stored value transaction vehicle;
receiving, by a transaction processing computing system, a request to load funds onto the stored value transaction vehicle;
determining, by the stored value transaction vehicle processing engine, to load the funds onto the stored value transaction vehicle based, at least in part, on meeting requirements of the stored value processing rule;
receiving, by the transaction processing computing system, transaction data from an entity for a purchase transaction, wherein the transaction data comprises an authorization request and identifies an account of a transaction vehicle, wherein the transaction processing computing system comprises the stored value transaction vehicle processing engine;
comparing, by the stored value transaction vehicle processing engine, the transaction data against the stored value processing rule;
determining, by the stored value transaction vehicle processing engine, the transaction vehicle is the stored value transaction vehicle based on the comparison;
determining, by the stored value transaction vehicle processing engine, to approve the authorization request based, at least in part, on meeting requirements of the stored value processing rule; and
processing, by the transaction processing computing system, a transaction associated with the transaction data using the stored value transaction vehicle, based at least in part on the determining to approve the authorization request.

32. The system of claim 31, wherein the stored value processing rule is applicable to a plurality of stored value transaction vehicles.

33. The system of claim 32, wherein the stored value processing rule is received from a transaction vehicle issuer system associated with the stored value transaction vehicle.

34. The system of claim 31, wherein the transaction velocity defines an acceptable spend limit within a spending period.

35. The system of claim 31, wherein receiving the stored value processing rule comprises receiving processing parameters for implementation of the stored value processing rule, wherein the processing parameters comprise any of a start date and an end date.

36. (canceled)

37. The system of claim 31, wherein the acceptable load velocity of the stored value processing rule comprises acceptable load velocities for each of a plurality of load transaction types.

38. (canceled)

39. One or more non-transitory computer readable media storing instructions which, when executed by one or more processors, cause the one or more processors to perform operations comprising:
receiving, at a stored value transaction vehicle processing engine comprising one or more servers operating on a network and implemented in an acquirer processor, a stored value processing rule defining at least a transaction velocity and an acceptable load velocity that restricts amount loaded onto a stored value transaction vehicle, wherein the acceptable load velocity include a first load velocity associated with cash-based loads and a second load velocity associated with deposit-based and/or account-transfer-based loads;
associating, by the stored value transaction vehicle processing engine, the stored value processing rule with the stored value transaction vehicle;
receiving, by a transaction processing computing system, a request to load funds onto the stored value transaction vehicle;
determining, by the stored value transaction vehicle processing engine, to load the funds onto the stored value transaction vehicle based, at least in part, on meeting requirements of the stored value processing rule;
receiving, by the transaction processing computing system, transaction data from an entity for a purchase transaction, wherein the transaction data comprises an authorization request and identifies an account of a transaction vehicle, wherein the transaction processing computing system comprises the stored value transaction vehicle processing engine;
comparing, by the stored value transaction vehicle processing engine, the transaction data against the stored value processing rule;
determining, by the stored value transaction vehicle processing engine, the transaction vehicle is the stored value transaction vehicle based on the comparison;
determining, by the stored value transaction vehicle processing engine, to approve the authorization request based, at least in part, on meeting requirements of the stored value processing rule; and
processing, by the transaction processing computing system, a transaction associated with the transaction data using the stored value transaction vehicle, based at least in part on the determining to approve the authorization request.

40. (canceled)

41. The one or more non-transitory computer readable media of claim 39, wherein the acceptable load velocity of the stored value processing rule comprises acceptable load velocities for each of a plurality of load transaction types.

42. (canceled)

43. The computer-implemented method of claim 23, further comprising:
generating, by the stored value transaction vehicle processing engine, a graphical user interface in a stored value dashboard for receiving the stored value processing rule.

44. The computer-implemented method of claim 43, wherein the stored value processing rule further defines a plurality of acceptable actions for authorizing one or more overrides at a stored value payment vehicle level or authorizing at least one real-time fees associated with the stored value payment vehicle, and wherein the plurality of acceptable actions are provided through and received via the graphical user interface of the stored value dashboard.

45. The computer-implemented method of claim 23, wherein the transaction velocity includes an acceptable number of transactions and an acceptable value of transactions during a spending period.

46. The computer-implemented method of claim 23, wherein the stored value processing rule further defines one or more location-based filters and user-type filters.

47. The computer-implemented method of claim 23, further comprising:
loading, by the stored value transaction vehicle processing engine, the funds onto the stored value transaction vehicle based, at least in part, on a load minimum threshold that defines a minimum allowable balance for the stored value transaction vehicle or a load maximum threshold that defines a maximum allowable balance for the stored value transaction vehicle.

48. The computer-implemented method of claim 23, wherein the stored value transaction vehicle processing engine is a backend subsystem for creating, activating, modifying, and/or executing the stored value processing rule.
